(19) United States
(12) Patent Application Publication
(10) Pub. No.: US 2004/0028307 A1
(43) Pub. Date: Feb. 12, 2004

(54) Thermal electric energy converter

(76) Inventor: Quentin Elias Diduck, Rochester, NY (US)

Correspondence Address: THOMPSON LAMBERT, SUITE 703D, CRYSTAL PARK TWO, 2121 CRYSTAL DRIVE, ARLINGTON, VA, 22202

(21) Appl. No.: 10/459,715

(22) Filed: Jun. 12, 2003

Related U.S. Application Data
(60) Provisional application No. 60/387,932, filed on Jun. 13, 2002.

(51) Int. Cl. G02F 1/01

(52) U.S. Cl. 385/1

(57) ABSTRACT

Thermal Electric Energy Converter, for use in converting electromagnetic energy directly into electrical energy, by utilizing a series of appropriately scaled electromagnetic wave guides constructed using semiconductor materials. The guiding structures produce high frequency electrical signals in response to radiation input that are then collected to common nodes to produce a continuous signal.

### CROSS-REFERENCE TO RELATED APPLICATIONS

This application claims priority from U.S. provisional application No. 60/387,932 filed Jun. 13, 2002.

### FIELD OF THE INVENTION

This invention relates “electromagnetic to electric” energy conversion for energy generation, thermal cooling, and electromagnetic signal reception, particularly in the thermal energy range.

### BACKGROUND OF THE INVENTION

Ambient thermal energy and electromagnetic energy tends to cause noise in circuits and also limits operating points of electronic devices. This is undesirable as it reduces the functionality of the devices. As well there are many uses for devices that can convert a modulated electromagnetic signal back into a decodable electrical signal. Thus it is desirable to have a device that responds to thermal radiation and can convert it back into electrical energy or electrical signals, particularly when the electromagnetic energy is in the infrared energy spectrum. Current thermal energy to electrical energy conversion devices that exist are either temperature measurement devices or low efficiency detection devices. These devices include thermocouples that produce energy when there is a difference of temperature across the device, and a thermal diode structure that is used for signal detection.

However, these devices all suffer at least one of the following disadvantages: (1) The inability to have dramatic cutoffs to frequency of operation, (2) the requirement of a temperature difference for operation, (3) the necessity of an external voltage source to bias the device, (4) the inability to act as a power source, (5) the inability to act as a cooling device, and (6) ambient energy recovery capabilities are limited or are non-existent.

Other methods of solving the cooling problem are often implemented by providing a way to rapidly draw away the thermal energy from the circuit by using cooling fans, or other cooling structures. This solution has the distinct disadvantage of complete energy loss without any recovery of the dissipated energy.

This invention combines the characteristics of waveguides and rectifiers to convert electromagnetic energy to electrical energy. It is well known that electromagnetic waves traveling down a waveguide structure induce fields into the surface of the guide, and that these fields in turn can induce currents in the guide if it is a conductor. The field patterns produced in the guide are well described using Maxwell's field equations. One can solve these patterns such that the maximum and minimum field values for a given frequency and given mode of operation are known, as shown in FIG. 6. In FIG. 6, the waveguide 60 has a field induced upon its surface, the field represented by lines with arrowheads indicating the polarity. The scale in radians along the z direction is normalized with respect to an arbitrary wavelength. Rectifying material characteristics are well known for their ability to limit current flow to one direction. By combining the characteristics of these two devices we end up with a device that converts high frequency electromagnetic energy into electrical energy.

### SUMMARY OF THE INVENTION

This invention combines the characteristics of an electromagnetic waveguide and the characteristics of rectifying materials to convert electromagnetic energy into electrical energy. This is achieved in one embodiment by creating the guide structure geometry such that it is made from rectifying layers with the center of the guide filled with a material of a higher index of refraction than the materials composing the rectifier. The rectifier is oriented such that the device is perpendicular to the path of maximum field potentials such as those shown in FIG. 6. This guide can be further modified such that its ends are closed off, or partially closed off such that it forms a resonant cavity, without loss of functionality, as shown, for example, in FIG. 5.

By placing the rectifier material in the path of maximum potential of the guide, it forces the electromagnetic energy that enters into the guide to be reduced in amplitude as the rectifier alters it. The energy clipped by the rectification process is now electrical energy. However, this electrical energy is a high frequency half-wave pulse and will rapidly decay back to thermal energy if it remains as such. The attenuation of this signal, using standard methods, can typically be described by:

α=((ω/2)(μσ))^{1/2}(Np/m), (1)

where ω, μ, σ are the angular frequency, permeability, and conductivity, respectively. Using this approximation, we realize that for wavelengths in the order of ten micrometers (infrared radiation) the distance is typically on the order of a wavelength before most of the energy is transformed back into electromagnetic radiation. Hence it is necessary to change this pulse into a lower frequency form of energy.

One method of achieving this is to connect several of these guiding structures in parallel such that pulses are slightly out of phase. By doing this one effectively creates a noisy DC power source or a DC pulse modulated signal source as shown in FIGS. 3(a), (b), and (c), provided that all the guide structures receive electromagnetic energy in the frequency range that they were designed for. FIG. 3(a) shows the input waveform as induced on the waveguide, FIG. 3(b) shows the waveform after rectification, and 3(c) shows approximately the results of combining multiple rectified waveforms in parallel.

The shape of the guiding structure may be any standard guide shape provided that the maximum and minimum potential points can be determined along the guide for the frequency range in question. The design preferably allows for the maximum amount of field interaction with the rectifying material to induce maximum voltages into the material. Hence the positioning of the rectifying structure depends upon the guide design. In a preferred embodiment, the rectifying structures compose the inside surface of the guide and are preferably aligned to the direction of surface current flow, or across regions of field potential maxima and minima. The frequency range of operation of the device is dependent upon several factors including the dimensions of the guide, the difference of index of refraction between the guide and the material that fills the guide, as well as the location of the rectifying material, the maximum frequency of the rectifiers, and of course the geometry of the waveguide itself.

The rectifier material is preferably treated such that it has low to no threshold voltage and a high frequency response, as it may have to respond to THz range frequencies (application dependent). Also the rectifying device is preferred to have a high conductivity.

This device and its design methodology are appropriate for use as an energy conversion device, energy recovery device, cooling mechanism, thermal sensor, infrared sensor, or high frequency antenna.

There is therefore provided according to an aspect of the invention a converter for converting electromagnetic energy to electric energy, the converter comprising a material transparent to the electromagnetic energy with an index of refraction surrounded by a material with a lower index of refraction, the two materials forming a waveguide, and a rectifier coupled to the waveguide and positioned to rectify the electromagnetic energy and form a positive and a negative region on the converter, from which a current may be drawn. The rectifier may be constructed with the surrounding material of the waveguide having alternating layers of p-type and n-type material, which may be separated by intrinsically neutral material. The rectifier may also comprise a ballistic rectifying structure, which may be formed on the inside of the surrounding material. Several converters may be incorporated in a cluster connected by conductive connectors or electronic components, and may be enclosed in an electromagnetic cavity, which may be comprised of black silicon.

### BRIEF DESCRIPTION OF THE FIGURES

Preferred embodiments of the invention will now be described with reference to the figures by way of example where like characters denote like elements and in which:

FIG. 1 is a single waveguide with 2 sides of the guide surfaces composed of bridge rectifiers, the image to the right shows a zoomed image of the ballistic rectifier structures.

FIG. 1(a) is a schematic of the ballistic rectifiers coupled to the waveguide.

FIG. 2(a) depicts the cross section of the THz speed Schottky diode structure.

FIG. 2(b) shows a ballistic bridge rectifier

FIG. 2(c) is the front view of a reduced scale ballistic rectifier composed of InGaAs and InP.

FIG. 3(a) shows a typical electromagnetic input waveform of arbitrary frequency.

FIG. 3(b) shows the resultant waveform after it has been converted from electromagnetic radiation into electrical energy.

FIG. 3(c) shows the resultant waveforms when an unequal length interconnects are used to connect 4 devices together.

FIG. 4(a) is a typical node configuration connecting 4 ballistic bridge rectifier based devices together with semi-equal length runners.

FIG. 4(b) is a typical configuration connecting 4 PN based devices together with semi-equal length runners.

FIG. 5 is a partial cross section of 2 devices encased in a black silicon cavity, with a possible path for incoming radiation being demonstrated.

FIG. 6 is a diagram of surface currents that dominate guide operation without rectifying materials in use.

FIG. 7 is a circuit diagram of a set of waveguide based converters connected to a load.

FIG. 8 is a single waveguide in a laterally striped rectangular configuration composed of PN material.

FIG. 9 is a single waveguide in a longitudinally striped rectangular configuration composed of PN material.

FIG. 10 shows the frequency distribution of a black body at 300K source.

FIG. 11 shows the power potential as a function of temperature and frequency range.

### DETAILED DESCRIPTION OF PREFERRED EMBODIMENTS

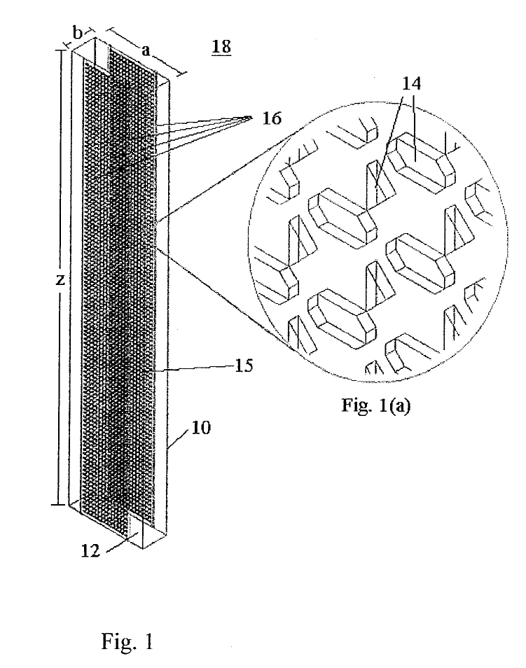

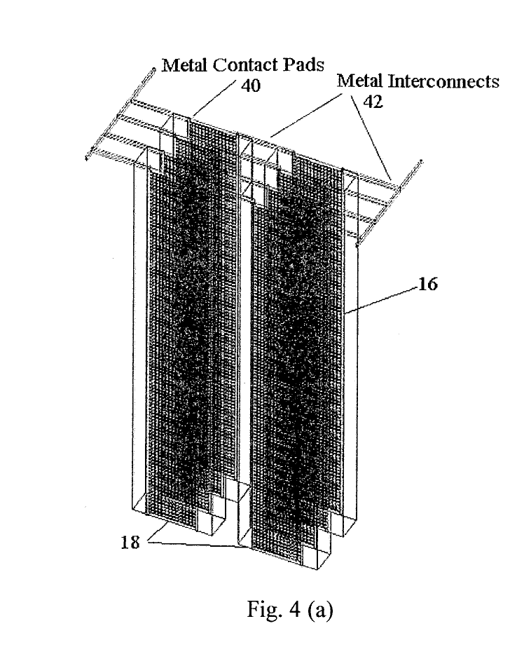

A preferred embodiment of the invention is shown in FIG. 1, where a converter 18 is fabricated by etching waveguide structures of a given width and thickness into an InGaAs substrate and doped such that a quantum well composed of InGaAs-InP enables the formation of ballistic bridge rectifier structures 15 within the confines of the guide. The rectifier structures 1 5 are coupled to the waveguide by being formed on the inside of the outer layer. The waveguide is generally composed of an outer layer 10 of a higher index of refraction than the inner material 12. The ballistic bridge rectifiers are shown in more detail in FIG. 1(a), in which 14 denotes regions that have been etched away, and in which the rectifiers are connected in series. The ballistic bridge rectifier structures have conductive contacts, such as metal contacts, that interconnect the ballistic bridge rectifiers, interconnect waveguides, and act as output contacts. In FIG. 1, the metal contacts 16 connecting the ballistic bridge rectifiers are shown, while the metal contacts interconnecting waveguides and acting as output contacts can be seen in FIG. 4(a). In this figure, the series of rectifiers are connected in parallel at each edge of the guide using metal connections 16. These connections are then interconnected to adjacent guides by implementing metal contact pads 40 and metal interconnects 42. FIG. 1 shows a rectangular guide with an internal width a, an internal height b and a depth z such that a>b. According to a preferred embodiment, the following can be used to define the dimensions of the waveguide structure: a>λ/2 is required in order for energy to be allowed into the waveguide, where a≈3b.

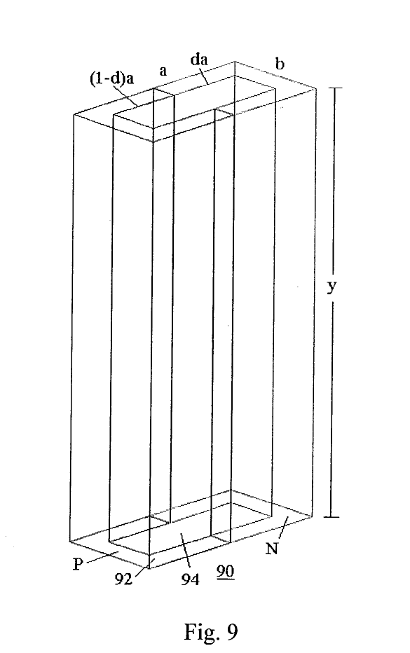

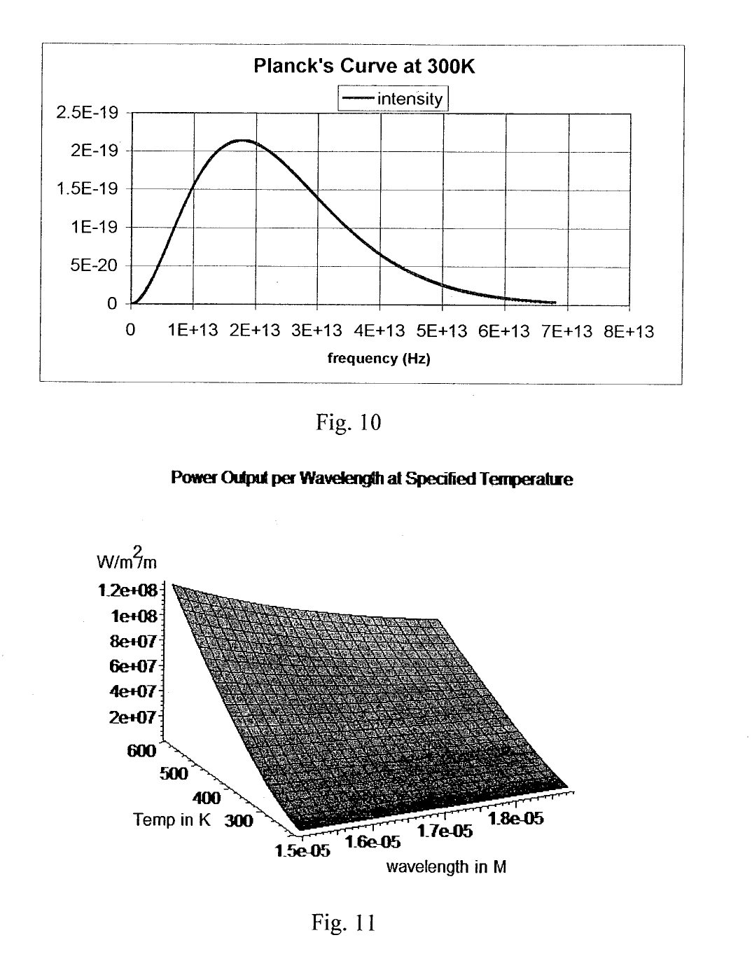

As an example, we will consider a black body at 300 K, which has a frequency distribution as shown in FIG. 10, where the vertical axis has units of Watts per meter squared (W/m²), and the horizontal axis is frequency (Hz). From the frequency distribution we observe that that majority of the energy is centered at around 16 to 20 THz. Thus the currents on the surface of the waveguide will be in about this frequency range. Utilizing the cutoff frequency of the guide one can eliminate the lower frequencies. Thus, it is possible to create a reasonably coherent electromagnetic energy source. In FIG. 11 we show the power distribution over the wavelengths of 15 microns to 18.75 microns (along the front of the graph), which correspond to 20 and 16 THz, respectively, and over a temperature range of 100K to 600K (side axis). The power output on the left of the chart is in Watts per square meter, per wavelength (in meters). This provides us with the magnitude of energy available for conversion as temperature changes. The area (not volume) underneath the curve at any one temperature is the amount of energy that can be extracted at that temperature. This example assumes a bandwidth of operation of 4 THz, which still leaves the signal reasonably coherent. This bandwidth can be increased with faster rectifiers. Given that the electromagnetic radiation within the structure is between 16 THz to 20 THz, we can assume that every 15 to 18.75 μm a new wave front exists. Random phase noise at the input doesn't pose a problem, as all the voltages end up half wave rectified to DC, producing a pulsed DC current in which the DC pulses sum together. Unlike with AC current, where additional energy can remove potential, the current can only increase with DC.

Solving for the size of the opening of the guide using:

ƒ_{TE10}=1/(2a\sqrt{με}) 16 THz=c/(2a) (2)

gives:

a=9.4 μm

Thus, for power generation in our example, a is 9.4 μm, and b is 3 μm according to the 1/3 rule presented above.

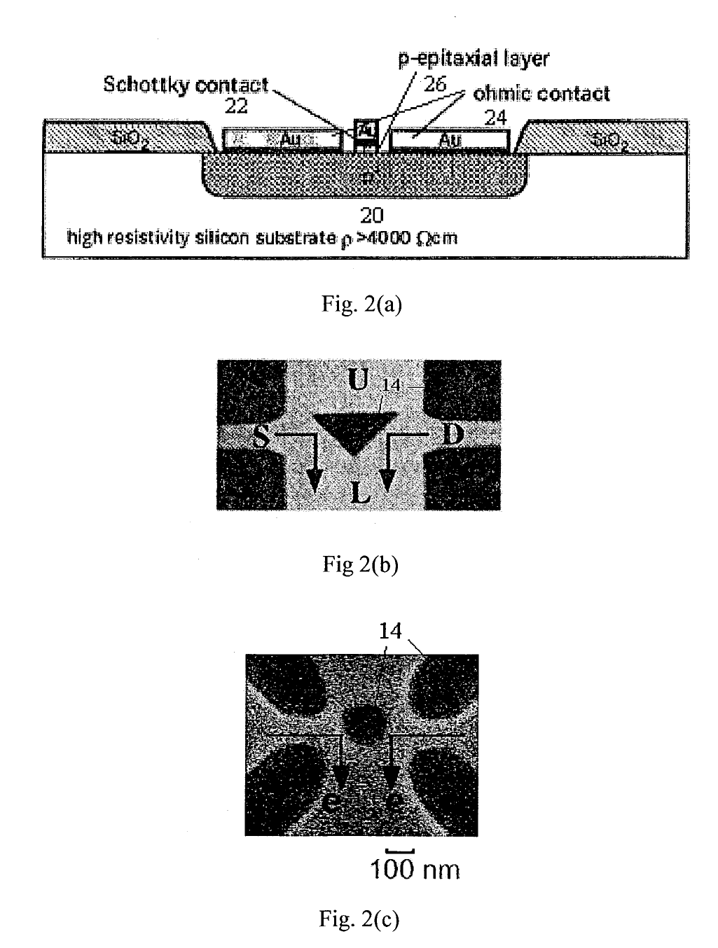

In order to generate DC pulses with incident infrared light, we require a rectifier that can operate in the THz frequency range, and in our example, up to approximately 20 THz. A preferred rectifying scheme utilizing ballistic rectifiers is shown schematically in FIG. 2(b). These devices have a very high frequency response, and virtually no threshold voltage. A low threshold is highly advantageous as it enables a larger percentage of the incoming energy to be fully rectified. While faster devices enable more power extraction, realization of this invention with devices that operate in the low THz region is possible. The ballistic rectifier is based upon the ballistic electron effect, where device feature size is small in relation to the mean free path of electrons. Thus electrons that encounter obstacles behave in a more or less Newtonian manner. This implies electrons travel in straight paths rather than in a drift manner, and thus we can use deflective structures to create changes in current paths. The dark areas 14 in FIGS. 2(b) and (c) are regions that were etched away, so as to cause deflections in the path of the electrons. Referring to FIG. 2(b), an AC source across points S and D causes ballistic electron motion, and the electrons will be deflected toward L as depicted in the figure. Since the electrons are deflected toward L, this leaves region U depleted of electrons. Thus one sees that this type of structure functions as a bridge rectifier. The efficiency of this device is directly proportional to the mean free path of the material, so in general the rectifier functions better at lower temperatures. However, as long as the mean free path is larger than half the size of the triangular structure, the device still functions. FIG. 2(c) is another ballistic bridge rectifier that acts similar to the one shown in FIG. 2(b), where the paths of the electrons are denoted e, and the electrons are also deflected by the etched area 14. These rectifiers can be fabricated on the inside of the higher index material in the waveguide to form an energy converter. A more detailed description of the formation of the ballistic rectifiers as described above can be found in “Operation of InGaAs/InP-Based Ballistic Rectifiers at Room Temperature and Frequencies up to 50 GHz” A. M. Song, P. Omling, L. Samuelson, W. Seifert, I. Shorubalko, H. Zirath, Jpn. J. Appl. Phys. Vol. 40, Pt. 2, No. 9A/B, 2001.

There will now be described an example of the fabrication of a device to operate in the frequency range of our example. The fabrication of the wave-guide structure starts from a InGaAs substrate that is first etched to create a well structure that is 100 microns long by 9.4 microns wide by 3 microns deep, corresponding to dimensions a, b, z in FIG. 1. This structure is then modulation doped such that a In_{0.75}Ga_{0.25}As/InP quantum-well structure is created. The properties of this structure are such that the electrons are confined to a two-dimensional electron gas in a 9 nm thick quantum well, located 40 nm below the surface. The rectifiers are defined using electron beam lithography and wet chemical etching. In FIGS. 2(b) and 2(c), the dark areas 14 are etched away, to create the rectifying layer 15 of FIG. 1 on the inside surface. The cavity left by the etching is then filled with SiO2, and an Aluminum metal layer is placed over top of the structure creating a guide structure. The two ends of the guide are left open for energy to flow through the structure. Note that only one side of the waveguide has the rectifiers etched into it, which is an alternative to both sides in order to simplify fabrication.

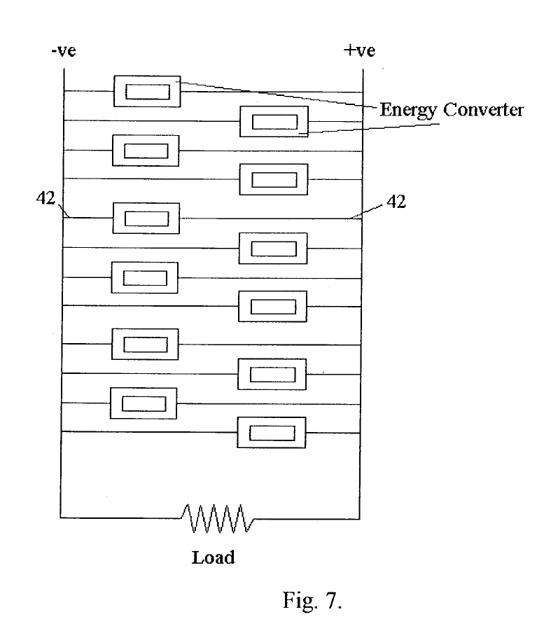

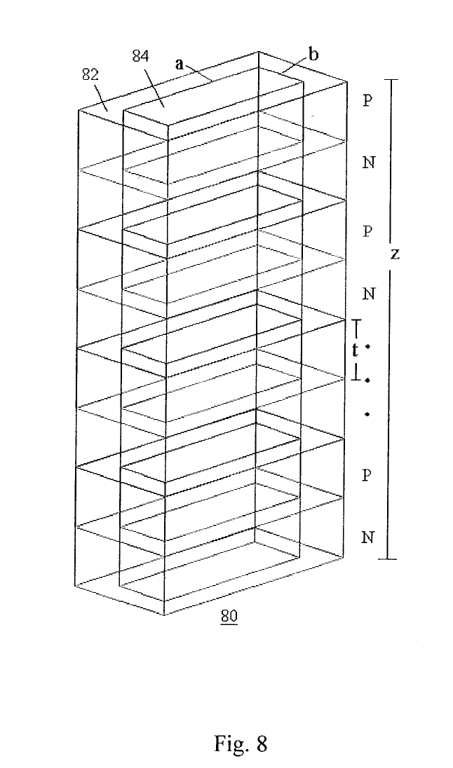

Schottky-type rectifying device developed by Karl M. Strohm et al. can also be used as an alternative to the ballistic rectifying scheme described above. These devices have achieved a 1 THz frequency limit using a silicon process in 1998. A cross section of a p-type diode is shown schematically in FIG. 2(a). The device is on a highly resistive silicon substrate 20, with a heavily doped p⁺ region. On this region are two ohmic contacts 24, separated by a layered structure consisting of a lightly doped p-epitaxial layer p, a schottky contact 22, and an Au layer on top. The fabrication procedure is described in detail in Strohm et al, “SIMWICC Rectennas on High-Resistivity Silicon and CMOS Compatibility”, IEEE Transactions on Microwave Theory and Techniques, Vol. 46, No. 5, May 1998. The Schottky structures are formed like the P-N structures shown in FIGS. 8 and 9 by substituting metal for the N structure.

Another alternate rectifying scheme for the energy conversion device is fabricated by etching waveguide structures into a silicon substrate such that layers of P material and N material of a given width and thickness are created within the confines of the guide, as shown in FIG. 8, where the converter is labeled 80, the layered outer material is labeled 82, and the inside of the waveguide is labeled 84. With this rectifying scheme, the rectifier no longer consists of the inside of the outer layer, but rather consists of the entire outside layer. The result is a series of PN junctions that act as rectifying diodes to the surface currents. There is preferably an even number of layers and the bottom and top layers have conductive contacts, such as metal contacts, used to interconnect the individual guides as well as for output contacts. In the near infrared that we are considering, the guide structure may be filled with SiO2 to enable the guide functionality, however, any substance with the appropriate transparency and index of refraction in the desired frequency range would be appropriate. For a rectangular guide with an internal width a, an internal height b such that a>b, and a depth z, the following equation defines the center of the locations of the PN layers:

$$z = [ ( k \frac{π}{2} ) - \frac{π}{4} ] λ , \qquad ( 3 )$$

where k is odd for P material and even for N material, and λ is the wavelength. Note that

$$a > \frac{λ}{2}$$

is required in order for the guide to allow energy into the guide, and that the thickness of each layer must not exceed

$$\frac{π}{2} λ$$

to prevent the P and N materials from overlapping. Also note that there must be a minimum of 2 layers for this device to function (a P and an N layer). The waveguides 80 can be connected as shown in FIG. 4(b) with metal contact pads 40 to the positive and negative terminals, and metal interconnects 42 for interconnecting the individual waveguides 80.

Alternatively, FIG. 9 gives an example of a more frequency independent solution to the idea of using P and N materials. The outer material 92 that covers the inner material of the waveguide 94 can also be layered along its height or width to form a converter 90, instead of being layered along its depth as in FIG. 8. In FIG. 9, a layer of P and of N are made to form a waveguide, the layers being along the width of the waveguide, but the layers could also be along its height. The layers are constructed such that 1-d of a is P material, and d of a is N material, such that d≦1−T, where T is the minimum thickness that the N material can be, and has been normalized with respect to a. These materials preferably run the full height (or width) of the guide as well as the full depth. This creates a rectifying diode structure along the width or height, as opposed to the depth discussed before. Increasing the depth of the structure increases the efficiency of the guide by allowing more energy to be extracted from the electromagnetic radiation as it interacts more with the rectifier. The structure should have a depth of at least 1 wavelength.

The process by which the electrical energy is extracted from ballistic bridge rectifiers and PN structures or schottky structures is somewhat different. Ballistic rectifiers add up like several batteries in series such that the current does not increase while the voltage increases. Also, the size of the rectifier is much smaller than the wavelength of the radiation. Thus the summation of the energy at the end of each rectifier string effectively adds up slightly out of phase since the velocity of electrons is less than the speed of light. Hence one wave-guide structure composed in this methodology should be sufficient to produce power, provided that the length of the guide is large in relation to the wave-length, which would be approximately 1.5 times as long, given the differences in speed. This is not the case with the PN junction versions, as the PN Junction or Schottky structures essentially act as one row of ballistic devices. The ballistic devices are bridge rectifiers and not diodes in terms of behavior.

Other rectification structures may be used. For example, the layered PN structure can be extended to include an intrinsic layer, forming a layered PIN structure. As with the PN structure, a minimum of 1 layer each must be present (for a total of 3 layers). Also, high-speed schottky diodes can be fabricated on the inside of the waveguide in the same configuration as the ballistic rectifiers to produce the necessary output signal. Other schottky structures such as a P-Metal device may also be used, as long as the frequency range is satisfied. The P-Metal device is a P-type semiconductor that has an abrupt metal contact such that the contact is not deeply engrained into the semiconductor. This provides diode action similar to how a PN diode functions, with the exception that it is now a heterostructure, and that the band gap energy prevents holes from moving across the junction while electrons are able to cross the junction.

The output signals from the guide structures are high frequency pulses, (half wave rectified signals of the original input signal, or full wave rectified in the case of the bridge rectifier). Hence the waveguide structures have to be in very close proximity, and preferably within a distance of 1 wavelength. According to a preferred embodiment of the invention, the structures are arranged so that the connections are clustered in such a way that they are interconnected within a distance of ½ of a wavelength such that any wire carrying just a single DC generated pulse is shorter than half a wavelength. Otherwise the majority of the energy will go back into thermal radiation. In the case of the ballistic bridge rectifiers, this means that any string connected in series shouldn't be more than one half a wavelength from the next string, or from an adjacent guide (if connected in parallel). Essentially, any location that generates a single pulse per electromagnetic wave that goes by has to be within half a wavelength of another structure that that could receive this wave. Fields of one wave could enter multiple guides, and thus should be arranged to add up. In operation, the output signal strength is highly attenuated and will lose approximately ⅓ of its amplitude within a distance of ½ a wavelength for near infrared frequencies.

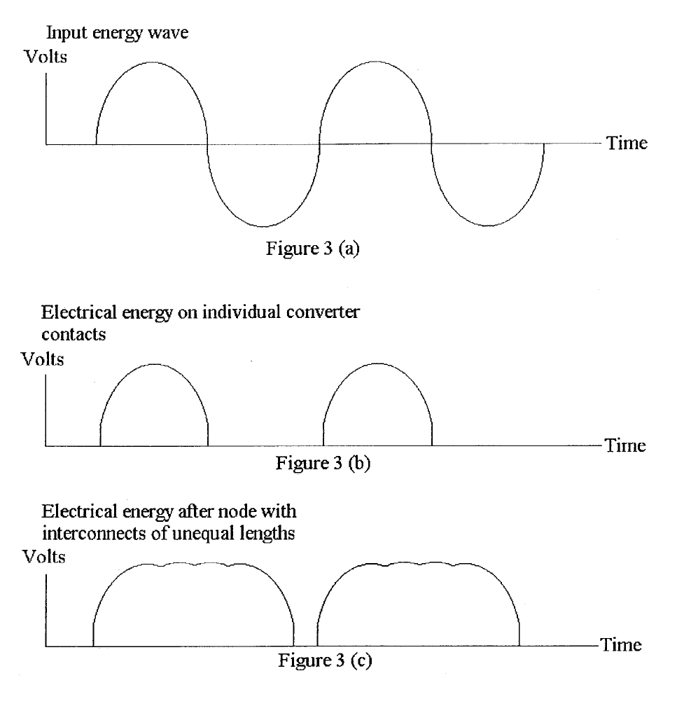

By interconnecting the guides with slightly out of phase distances, such that signals of similar amplitude are out of phase, one creates a lower frequency pulse that can effectively become a DC source, with a sufficient number of guides. When this device is designed for signal reception, the phase-offset between devices is arranged such that the signal is more in phase rather than offset in phase. In this case one has to consider bandwidth limitations over signal strength, and signal propagating distances. If the interconnects are designed such that 4 guides are used to form a node as in FIG. 4(a), each should have an interconnect length difference of ¼ of a wavelength in relation to each other such that the output signal will effectively be a DC pulse of 1 wavelength (see FIG. 3(c)). FIG. 4(b) shows another cluster of converters, but this time the converters have a layered PN structure. By preferably interconnecting these pulses so that they are out of phase at a common node point one is able to create lower frequency pulses that are able to travel much longer distances. These interconnects do not have to be conductive metals, but could also be made up of other circuit elements common to the field that would cause the pulses to be out of phase. This is to be continued until either the desired bandwidth/propagation distance requirements are met, or such that the signal is a (noisy) DC source, if required.

When these devices are used for signal reception, the design of these interconnections describes how the signal will be reconstructed from electromagnetic waves. For the most part this can be exactly the same as for power generation if Amplitude Modulation is used or if the modulation is of low bandwidth. What is important is that the length of the wires essentially dictates efficiency, and the shorter the wires are the better. The summation of phases leads to a coherent DC source. If the source is a random source and there are enough structures it doesn't matter how they are setup as long as the lengths of wire are short enough so that the energy can sum together (on the order of less than half a wavelength). If the source is a coherent source, then the structure should be structured so the lengths of wire cause the energy to be phased together. In this case, a series of out of phase pulses are combined on to one wire so that when together there is no space between pulses, i.e. DC.

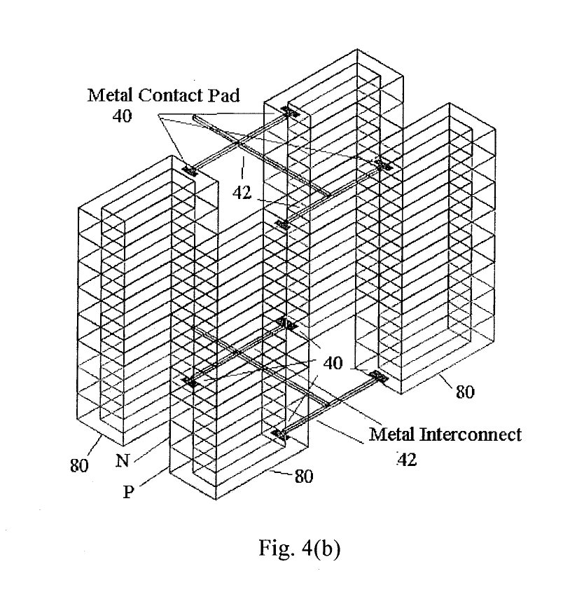

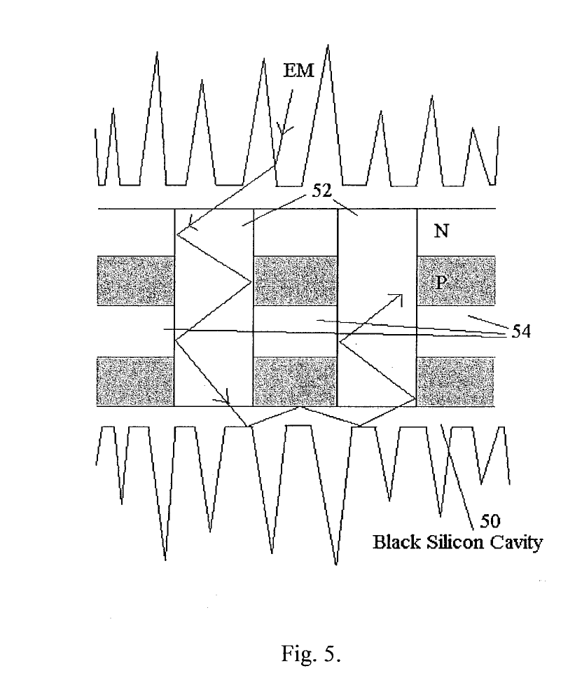

For power generation purposes it is preferred to surround the guide or cluster of guides with an internally reflective cavity 50. This cavity is preferably composed of black silicon for infrared radiation, as shown in FIG. 5, but other materials could be substituted by one skilled in the art if the device was to operate in the optical or other region of the electromagnetic spectrum. Black silicon naturally has a jagged and peaked structure, as shown in the figure, and the jagged nature enables electromagnetic radiation to enter but prevents it from escaping because of the refraction and reflection effects caused by air-silicon interface. FIG. 5 shows the electromagnetic radiation EM depicted as a ray entering the cavity 50, and being reflected internally along the waveguide 52 as well as inside the cavity, passing through the device 54 composed of P type and N type regions, denoted P and N respectively.

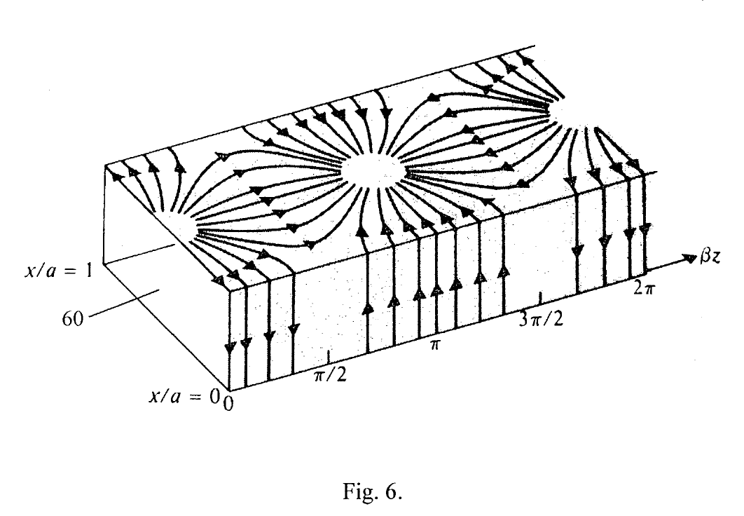

FIG. 7 shows an example of how the energy converters 70 as described in the disclosure can be used as a power source. As shown, they are connected in parallel by the metal interconnects 42 with all the positive contacts connected to the node labeled +ve, and all the negative contacts are connected to the node labeled −ve, however, any arrangement that is commonly used to connect power sources can be used, depending on the desired application. A load can then be connected to +ve and −ve.

Multiple waveguides need not be present for an application. Individual waveguide can be used in different applications. As mentioned above, an individual ballistic design could function on its own as a power generating device (albeit a very low power one). The other devices could be used as part of a reception system or even a power generation one, but the energy produced would be high frequency pulse modulated.

Immaterial modifications may be made to the embodiments set forward in this disclosure by those skilled in the art without departing from the essence of the invention.

What is claimed is:

1. A converter for converting electromagnetic energy to electric energy, the converter comprising:
a material transparent to the electromagnetic energy with an index of refraction surrounded by a material with a lower index of refraction, the two materials forming a waveguide; and
a rectifier coupled to the waveguide and positioned to rectify the electromagnetic energy and form a positive and a negative region on the converter, from which a current may be drawn.

2. The converter of claim 1 in which the rectifier comprises the surrounding material having alternating layers of p-type and n-type material.

3. The converter of claim 2 in which the surrounding material having alternating layers of p-type and n-type material, the layers being separated by intrinsically neutral material.

4. The converter of claim 1 in which the rectifier comprises a ballistic rectifying structure.

5. The converter of claim 4 in which the rectifying material comprises the inside of the surrounding material.

6. The converter of claim 1 in which the rectifier comprises a schottky diode structure.

7. The converter of claim 6 in which the rectifying material comprises the inside of the surrounding material.

8. The converter of claim 1 in which the rectifier comprises a p-metal material.

9. A cluster of converters, the cluster comprising two or more converters of claim 1, the converters connected by conductive connectors.

10. A cluster of converters, the cluster comprising two or more converters of claim 1, the converters connected by electronic components.

11. The converter of claim 1 in which the converter is enclosed in an electromagnetic cavity.

12. The electromagnetic cavity of claim 11 in which the cavity comprises black silicon.

13. The cluster of converters in claim 1 in which one or more converter in the cluster is enclosed in an electromagnetic cavity.

14. The electromagnetic cavity of claim 13 in which the cavity comprises black silicon.

15. The cluster of converters of claim 11 in which the converters are connected out of phase such that the signal across the positive and negative region is a DC voltage.

16. An electromagnetic energy to electric energy converter comprising:
a structure defining an electromagnetic wave-guide, the structure having a region in which electric currents flow upon propagation of electromagnetic energy within the wave-guide, the region having a positive region and a negative region;
a positive conductive contact in the positive region for connection into an electric circuit, and a negative conductive contact in the negative region for connection into the electric circuit.

17. The converter in claim 16 in which the guide is constructed in a semiconductor substrate.

18. The converter in claim 16 in which the positive region and negative region are separated by rectifying PN material.

19. The converter of claim 18 where the rectifying materials are separated by an intrinsically neutral material.

20. The converter in claim 16 in which the positive region and negative region are separated by rectifying P-Metal material.

21. The converter of claim 20 where the rectifying materials are separated by an intrinsically neutral material.

22. The converter in claim 16 in which the positive region and negative region are separated by rectifying metal-insulator-metal material.

23. The converter of claim 22 where the rectifying materials are separated by an intrinsically neutral material.

24. The converter in claim 16 in which the positive region and negative region are separated by a ballistic bridge rectifying structure.

25. The converter in claim 16 in which the rectifying materials comprise the inside surface of the guide.

26. The converter in claim 23 in which the guide structure is filled with a dielectric, or insulator material, or a combination thereof.

27. A cluster of converters, each converter comprising the converter of 16.

28. The cluster of converters in claim 25 in which all the converters are interconnected using conductors, semiconductors, or electrical circuit elements.

29. The cluster of converters in claim 25 in which all the converters are interconnected using optical wave-guides, or optical circuit elements.

30. The converter in claim 16 in which all or some of the converters are encased in an electromagnetic cavity.

31. The cluster of converters in claim 25 in which all or some of the converters are encased in an electromagnetic cavity.

32. The cluster of converters in claim 28 where the cavity is composed of black silicon.

33. The cluster of converters in claim 29 where the cavity is composed of black silicon.
